(19) United States
(12) Patent Application Publication
(10) Pub. No.: US 2013/0222330 A1
(43) Pub. Date: Aug. 29, 2013

(54) METHOD AND SYSTEM FOR SELECTIVELY SAMPLING DATA FROM RESISTIVE TOUCH PANELS

(71) Applicants: Lynn R. Kern, Tucson, AZ (US); Srinivas K. Pulijala, Tucson, AZ (US); Ken Gay, Tucson, AZ (US)

(72) Inventors: Lynn R. Kern, Tucson, AZ (US); Srinivas K. Pulijala, Tucson, AZ (US); Ken Gay, Tucson, AZ (US)

(21) Appl. No.: 13/408,940

(22) Filed: Feb. 29, 2012

(51) Int. Cl. G06F 3/045

(52) U.S. Cl. 345/174

(57) ABSTRACT

The present disclosure provides a selective data acquisition system of a matrix resistive touch panel and a method of using the data acquisition system to selectively acquire data on a touch panel. Each analog signal from the sensing track is tested with its own threshold value to determine whether the characteristics of the analyzed signal are sufficient to constitute a user's actuation on the touchscreen. If the analyzed analog signal exceeds or otherwise clears the threshold, the selective data acquisition system converts the signal into a digital word. Conversely, if the analyzed analog signal falls below or otherwise fails the threshold, the selective data acquisition system does not convert the signal. This process continues for all analog signals from the sensing tracks.

### TECHNICAL FIELD

The present invention relates generally to analog circuit design, and more particularly, to the design of an electronic analysis circuit for a matrix touch panel.

### BACKGROUND

Touchscreens are becoming a primary human-computer interaction mechanism in a variety of computing devices. Touchscreens enable the user to interact directly with the content displayed on the screen without requiring extraneous peripherals. Rather than using a keyboard or a mouse, a user can transfer information through a touchscreen by touching an icon or by writing or drawing on a screen. Not only does employing a touchscreen provide an improved user experience, it also reduces the overall size of the device. For these reasons, touchscreens have been increasingly employed in a variety of portable and functional electronic devices such as smartphones, tablet computers, and portable video game consoles.

Many schemes have been proposed for touchscreen construction, some of which have met with commercial acceptance. For example, resistive touchscreens are growing in popularity due to their durability and ability to handle more precise user commands, via stylus or any other object. A. typical resistive touchscreen utilizes two flexible sheets that are separated by a gap and coated with a resistive material. Whenever something touches and applies pressure to the resistive screen, the two separated sheets come in contact with one another and registering the location of that touch.

Some of the more recent resistive touchscreens are implemented with a matrix of conductive tracks having power supplying means on one of the two axes. On the other axis, electrical characteristic sensing means are employed. For instance, the columns of the matrix are sequentially driven with a predetermined voltage, and the signal level on each row is measured sequentially one after another. When one of the columns is placed under voltage, the other columns are in high impedance to prevent the propagation of current into the latter. While the value on the first row is being measured, all other rows are connected to the ground. Then, the value on the second row is measured while all other rows are connected to the ground. Once values have been measured on every row, the first column passes into the high impedance state, and the second column is driven with the voltage. Measuring the level on each of the rows is then repeated. The scanning process is performed in this manner up to the last column. The described process is repeated rapidly to create the image of touch actuation points on the touch panel. Such configuration allows for simultaneous detection of multiple contacts on the touch panel.

In such resistive touch panel implementations, however, the readings on the rows are subject to interference and problems linked to the resistivity of the materials used in constructing the matrix. For example, the Indium-Tin Oxide (“ITO”) used in constructing the columns and rows yields a resistance as high as 60 kΩ. The potential measured at a given point therefore isn't always as expected, thereby making it harder to accurately determine the coordinates. When multiple contacts are made to one driving column, the potential measured at the isolated point could be too low to be detected. Larger screens require longer tracks of ITO, resulting in even higher resistance, which significantly hampers the accuracy and the sensitivity of the touch panel. The rise time of the transient signal also varies from one point to another, further complicating the signal to coordinates conversion process.

Attempts have been made to solve the aforementioned problems. One solution is to use programmable series resistances placed at the exciter outputs on the driving tracks and the receiver inputs on the sensing tracks to normalize the transient signals over the matrix. For instance, variable resistors have been used to attenuate the signals on the driving tracks so that all drive signals have the same appearance and shape. By normalizing the driving signals, the readings on the sensing tracks can be scaled. This allows for a universal threshold value to determine whether the observed signal is sufficient to be considered as an actuation on the panel.

The aforementioned solution, however, has a number of distinct disadvantages. The driving signals are intentionally attenuated, and it limits the usable signal level range on the sensing tracks. For example, the signal level measured at the receiver input of a sensing track can range from 100 mV to 1V from a 3.3V excitation. With the reduced signal, the rise time also slows down. This solution, in effect, intentionally makes all. touch responses as slow as the slowest detection point of the touch panel, in exchange for a universal threshold value. Unfortunately, the universal threshold value hardly provides any benefit for the actual performance on the touch panel. With such vast decrease in amplitude of the signals on the sensing track, the systemic noise consumes almost half of the dynamic range of the ADC. Driving the panel with the higher power means wasting more power on the device employing the touch screen. Furthermore, in a single threshold based scanning approach, all analog input signals on the sensing tracks need to be digitized to pin-point the touch actuations once any signal goes over the threshold. Not only does this method decrease the performance of the touch panel, it also consumes more power, which is often considered as a critical design flaw in portable devices.

Therefore, there remains a need for a system and method for accurately scanning the touch panel efficiently without sacrificing the speed or the power consumption.

### SUMMARY

One embodiment of the present disclosure is a selective data acquisition system for a resistive touch panel. The selective data acquisition system comprises a memory for sampling an analog signal from a plurality of sensing tracks in the touch panel. The system further comprises a control logic that performs a threshold check on a sampled analog signal by using a distinct threshold that corresponds to the sampled analog signal. The control logic is configured to prohibit a conversion of the sampled analog signal when the sampled analog signal fails the threshold check. The selective data acquisition system includes a source of thresholds that provides a plurality of thresholds to the control logic. Each threshold provided to the control logic is optimized to determine a touch actuation from the analog signal sampled from, each of the sensing tracks.

In one embodiment, the selective data acquisition system comprises an analog-to-digital converter (ADC), which also functions as a variable threshold checker for the system. The system also comprises a data source, which is operable to provide threshold data to the variable threshold checker. The threshold data is a distinct threshold optimized for the sampled analog signal.

In one embodiment, the ADC implementing the selective data acquisition system is a successive approximation register analog-to-digital converter (SAR ADC). The SAR ADC comprises successive approximation register (SAR) control logic to provide a digital output; a digital-to-analog converter (DAC) to convert the digital output of the SAR control logic into an analog feedback signal; and a comparator to compare the analog feedback signal with the sampled analog signal to provide a control signal to the SAR control logic.

In an aspect, the present disclosure relates to a method for selectively acquiring data from a matrix touch panel using an analog-to-digital converter. First, an analog signal from a sensing track of the matrix touch panel is sampled. The sampled analog signal is then analyzed by using a distinctive threshold tailored for the sampled signal to determine whether one or more of characteristics of the sampled analog signal are indicative of a touch actuation. If the sampled analog signal meets the threshold, the ADC converts the sampled analog signal into a digital word. In an embodiment, the ADC is a successive approximation register ADC, and the sampled analog signal is converted by using a normal SAR operation. In an embodiment, a data ready signal is provided at the end of the conversion to indicate that the ADC is ready to output valid data. In the event that the sampled data does not. meet the threshold, the ADC is configured to output a predetermined default data. The data ready signal is provided to indicate that the output data of the ADC, the predetermined data in this case, is valid.

By using the selective data acquisition system of this disclosure, analog input signals on non-responsive sensing tracks are not digitized. This minimizes the scanning time of the panel, which also positively contributes to the power consumption. Most importantly, the signals from the driving tracks do not have to be intentionally attenuated for normalization purposes. Varying rise time on each of the driving signal is no longer an issue. Since each analog input signal is tested with its distinct threshold value, threshold value can be adjusted for the fluctuations caused by non-normalized driving signals. Non-attenuated driving signals provide leaves the signals on the sensing tracks at higher amplitude, and it can help to reduce systemic noise. Also, the system is left with a greater range of usable analog input signals on the sensing tracks. This increase in the usable range of analog signal, when coupled with the variable threshold scheme of the data acquisition system, provides greater latitude in tuning the user's touch level per application without sacrificing wither amplitude or AC response. Further objects, features, and advantages of the present invention will become apparent from the following description and drawings.

### BRIEF DESCRIPTION OF THE FIGURES

FIG. 1 is a high level block diagram of an exemplary selective data acquisition system according to embodiments of the present disclosure.

FIG. 2 is a schematic block diagram of an exemplary scan engine employing a successive approximation register ADC, according to embodiments of the present disclosure.

FIG. 3 is a flowchart illustrating an exemplary method of using a selective data acquisition system in accordance with an embodiment of the present disclosure.

FIG. 4 is a timing diagram illustrating an operation of an exemplary selective data acquisition system according to an embodiment, when the sampled analog input signal exceeds the threshold.

FIG. 5 is a timing diagram illustrating an operation of an exemplary selective data acquisition system according to an embodiment, when the sampled analog input signal fails below the threshold.

While the invention is amenable to various modifications and alternative forms, specific embodiments are shown by way of example in the drawings and are described in detail. It should be understood, however, that the drawings and detailed description thereto are not intended to limit the invention to the particular form disclosed, but on the contrary, are intended to cover all modifications, equivalents, and alternatives falling within the spirit and scope of the present invention as defined by the appended claims.

### DETAILED DESCRIPTION

### Overview

The following detailed description is made with reference to the figures. Exemplary embodiments are described to illustrate the claimed invention, not to limit its scope, which is defined by the appended claims.

A selective data acquisition system in a matrix resistive touch panel and a method of using the selective data acquisition system for selectively sampling analog input signals from the matrix resistive touch panel are described herein.

Each analog signal from a sensing track has different electrical characteristics, such as the rise time, amplitude, and other AC characteristics. When scanning a matrix resistive touch panel, referred herein as “touch panel,” to detect one or more actuation points, the selective data acquisition system of the present disclosure uses a variable threshold value on each of the analog signals from the sensing tracks. Each analog signal from the sensing track is tested with its own threshold value to determine whether the characteristics of the analyzed signal are sufficient to constitute a user's actuation on the touchscreen. If the analyzed analog signal exceeds or otherwise clears the threshold, the selective data acquisition system converts the signal into a digital word. Conversely, if the analyzed analog signal falls below or otherwise fails the threshold, the selective data acquisition system does not convert the signal. This process continues for all analog signals from the sensing tracks.

As one would expect, this configuration minimizes the scanning time of a panel. Not only does the reduced scan time make the panel more power efficient, it improves the tracking performance by increasing the response rate of the panel. Yet, the principal advantage of this configuration is that the independent threshold mechanism eliminates the need for intentionally attenuating the signals from the exciter of the driving tracks. Since the signals detected on the sensing tracks are analyzed independently, the driving signals need not be normalized.

As mentioned above, the systems and the methods of the present disclosure may be implemented by using a SAR ADC to perform both the threshold check and signal conversion. However, it should be noted that the exemplary embodiments of the present disclosure uses SAR architecture as a convenient example, because a SAR ADC operation lends itself well to a detailed explanation of the basic idea in this present disclosure. Accordingly, any system architecture, which allows an input signal to be sampled onto a memory device (e.g., capacitor) for performing a threshold check prior to a conversion, can implement the selective data acquisition system of the present disclosure.

### Exemplary System

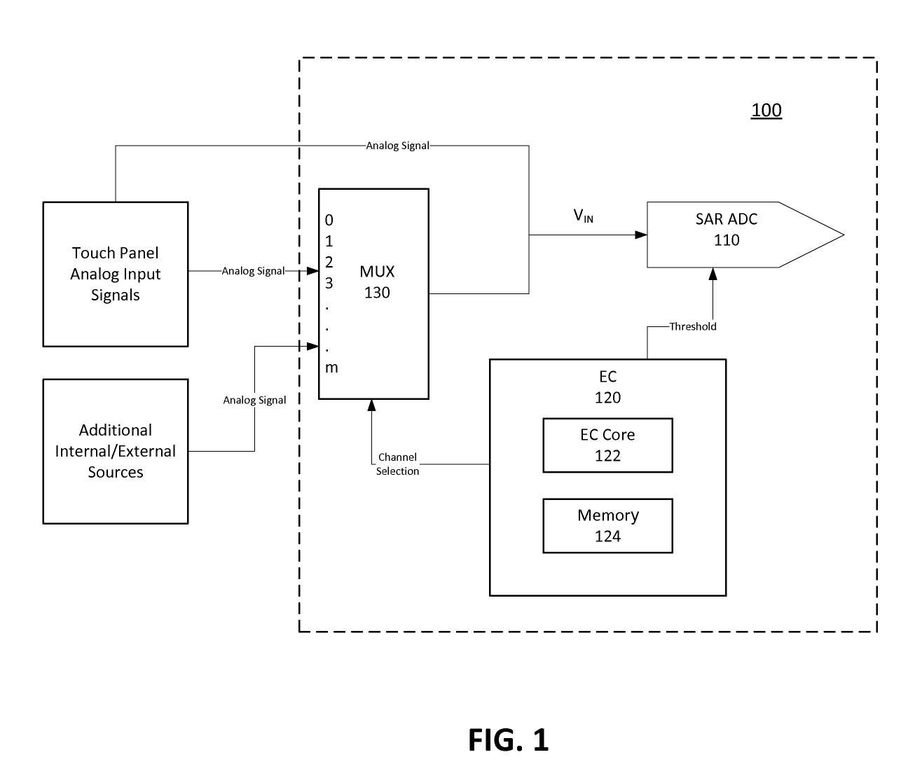

FIG. 1 is a schematic block diagram of a selective data acquisition system 100, referred hereinafter as “System” according to an embodiment of the present disclosure. The system 100 comprises a successive approximation register analog-to-digital (“SAR ADC”) 110, and an embedded controller (“EC”) 120.

The EC 120 may comprise an EC core 122, and one or more memories 124. As is known in the art, the memory 124 may comprise random access memory (“RAM”) as well as a read only memory (“ROM”), which can be implemented by a variety of memory devices or architectures, such as reprogrammable memory and/or any circuitry that stores operational instructions. For example, the RAM may be implemented on-chip as a Static RAM. The ROM may be provided as an on-chip Flash/EE memory, containing program and associated data portions. The EC core 122 may provide various operating modes, such as Scan, Conversion, or Power Down, to the SAR ADC 110. In some embodiments, the EC core 122 may be configured to adjust various other parameters for the SAR ADC 110. For instance, the EC core 122 may command the SAR ADC 110 to operate in a high/low conversion resolution mode, a fast/slow scan mode, or any other operable modes for flexible power and performance management in various applications. It should be noted that the EC 120 may also be provided as a microprocessor, a programmable micro controller, or a state machine and/or logic circuitry.

While it is possible to provide a dedicated analog input channel for the touchscreen input signals to the SAR ADC 110, the selective data acquisition system 100 may be coupled with a multiplexer (“MUX”) 130 having multi-channel signal inputs 0 through m. Each channel can be configured for each of the measuring tracks of a touch panel to be presented for conversion via the analog input signal “V_{IN}”. In an embodiment, the SAR ADC 110 may select a channel from channels 0 through m of the MUX 130 via a channel selection signal. In some cases, the channels of the MUX 130 can also be configured to provide signals from any other external sources and/or internal sources, and the EC 120 may provide a MUX channel signal to the MUX 130. As is readily apparent by those skilled in the art, the number of channels and their designation can be set out by the circuit architecture and configuration of the selective data acquisition system 100.

As previously noted, the selective data acquisition system 100 uses an independent threshold for each analog input signal from the sensing tracks. Accordingly, in one embodiment, a set of predetermined threshold values corresponding to each of the sensing tracks is stored in the memory 124 of the EC 120. For example, a firmware of the device employing the touch panel can be pre-loaded with the set of threshold values. In this setting, the EC 120 may be responsible for selecting the correct threshold for analyzing a given V_{IN}. This may be implemented by having the EC 120 provide a channel selection signal to the MUX 130 as well as provide the matching threshold data to the SAR ADC 110. In an alternative embodiment, a set of predetermined threshold values can be provided to the SAR ADC 110 sequentially as the SAR ADC 110 signals the EC 120 for the next threshold data. Of course, a number of logic implementations can perform the same functionality. It is sufficient that the SAR ADC 110 receives an independent threshold value for each V_{IN} being analyzed.

An analog signal has a set of signal characteristics that can fluctuate depending on the circuit architecture, configuration, and particularly, the material used in constructing the circuit. For example, the Indium-Tin Oxide (“ITO”) used in constructing the tracks of a typical panel yields as much 60 kΩ resistance. Nevertheless, one can predict the characteristics of the analog input, signal if the circuit architecture and configuration is laid. out. While a variety of signal characteristics may be used for checking the touch actuation on the panel, some signal characteristics may be more distinguishable and predictable than others. Accordingly, in one embodiment, the output level of the signal is used as the threshold. As will be discussed in detail below, a comparator of the SAR ADC 110 can compare the V_{IN}, which would be the actual output level of the analog signal observed by the receiver of the sensing track, against the expected output level on that sensing track. Other AC characteristics, for example, a rise/fall time of the signal can be measured, and the expected rise/fall time can be used as the threshold for scanning the panel. In yet another embodiment, the threshold is a range of values suitable to distinguish the signal characteristic between touch responsive signals and non-touch responsive signals.

Moreover, in some cases, the EC 120 may adjust the threshold before providing the threshold data to the SAR ADC 110. The adjustment can be made based on extra information obtainable through various internal/external components. For example, the EC 120 may adjust the threshold value based on various environmental factors, such as weather, or even based on the type of application running on device employing system 100. To achieve this, the EC 120 may be configured to obtain a static or dynamic threshold compensation value from internal/external components or software, and adjust the base threshold data. In some other embodiments, the threshold can be adjusted based on the operating mode of the selective data acquisition system 100.

Once the analog input signal, V_{IN} is determined to be over, or otherwise pass the threshold, the SAR ADC 110 converts the analog input signal V_{IN} into a digital output. As known in the art, the conversion process uses the power supplied to the ADC, sometimes referred as the reference voltage. Increase in the conversion performance and accuracy may be realized by tailoring the reference voltage used for the conversion process. In this regard, the selective data acquisition system 100 may comprise a means for selecting a reference voltage from a plurality of selectable reference voltages for the SAR-ADC 110. For instance, one or more of channels on the MUX 130 may be used as additional power sources. The EC 120, acting on software or firmware instruction, may configure the voltage reference V_{REF} using the additional power sources. Upon finishing the conversion, the SAR ADC 110 may provide the output to the EC 120 for further processing.

The selective data acquisition system shown in FIG. 1 can be implemented as part of a system-on-a-chip (“SOC”) device, as a component to a hand-held device, as a personal computer plug-in data-acquisition board, as a personal-computer external data-acquisition system, etc. As can be readily appreciated by those skilled in the art, various circuit configurations and arrangements may be provided to implement the functionality of the components described above.

### Analog-to-Digital Conversion

As discussed above, the selective data acquisition system 100 of the present disclosure functions as an efficient scanning engine for a matrix resistive touch panel. This is achieved by using an independent threshold for each of the analog input signals from the sensing tracks. By using the threshold check mechanism, only the signals that exceed, or otherwise meet the threshold value, are converted. Using the variable threshold value also eliminates the need for normalizing the signals on the driving tracks, and it provides a greater range of usable signal level on the sensing tracks. Notably, this solution can be implemented by using the components commonly found in any ADC architectures. In other words, the improved functionality of the data acquisition system is obtainable without consuming any additional power or silicon on the device, or even incurring extra manufacturing cost.

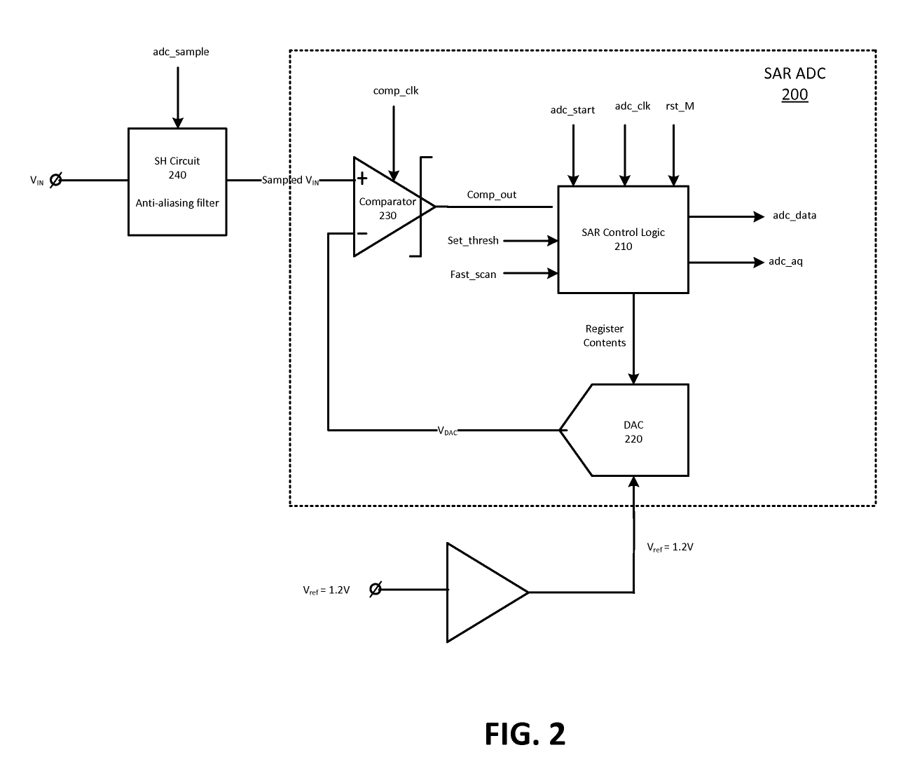

FIG. 2 is a schematic block diagram of a SAR ADC 200 according to an embodiment of the present disclosure. The SAR ADC 200 comprises SAR control logic 210, a digital-to-analog converter (“DAC”) 220, and a comparator 230. In this exemplary SAR ADC 200, a sample-and-hold (“SH”) circuit 240 is operably coupled to the comparator 230. The SH circuit 240 provides a sample state and a hold state for processing varying analog signal input values or analog signals that change at a rate greater than the conversion speed of the SAR-ADC 200. Accordingly, the SH circuit 240 operates to generate a selectively sampled and held representation of the analog signal inputs.

The “adc_start” signal provided to the SAR control logic 210 starts the operation of the SAR ADC 200. The “adc_start” signal may be provided by the EC 120, or any other suitable internal/external components of the selective data acquisition system 100. As mentioned earlier, the EC 120 may control the operating mode of the SAR ADC 200. Just by way of an example, the “adc_start” signal may be used to put the SAR ADC 200 into the Idle or power saving mode for power management. In a preferred embodiment, however, an additional signal, such as the “Fast_scan” signal, is used for a more detailed mode switching mechanism. For instance, asserting the “Fast_scan” signal can configure the SAR ADC 200 to operate as a touch panel scan engine. Conversely, de-asserting the “Fast_scan” signal can force the SAR ADC 200 to operate as a classic SAR ADC suitable for other functions of the device.

Although not shown in this figure, the SAR control logic 210 comprises at least one n-bit register. The n-bit register can be set to the data received via the “Set_thresh” signal, which configures the DAC 220 to provide the analog feedback signal corresponding to the threshold. As discussed earlier, the “Set_thresh” signal may be provided from the EC 120, or any other internal/external components capable of identifying a corresponding threshold data for the sampled V_{IN}. If the sampled V_{IN} passes the threshold check, then the n-bit register of SAR control logic 210 is cleared and reset for converting the sampled V_{IN} using the usual the conventional SAR operation.

A reference voltage is provided to the DAC 220 (e.g., 1.2V), and the output, V_{DAC}, is provided to the comparator 230. The V_{DAC} is determined based on the contents of the n-bit register in the SAR control logic 210, which is an 8-bit register in this exemplary implementation. As known in the art, the conversion resolution correlates the number of bits in the register. Of course, the size of the register used in various embodiments in this disclosure is an example, which may be increased or reduced as desired for a suitable conversion resolution. Theoretically, 8-bit resolution requires 8 clock cycles for providing a digital output, but the maximum clock rate can vary on the settling time of the DAC 220 and the comparator module 230.

The comparator 230 compares the V_{DAC} and the sampled V_{IN}, and provides the “Comp_out” signal to the SAR control logic 210. When analyzing the sampled V_{IN} against the threshold, the resulting “Comp_out” signal indicates whether the sampled analog input signal exceeds or otherwise passed the threshold. Accordingly, the assertion or de-assertion of the “Comp_out” signal will control whether the SAR ADC 200 converts the sampled V_{IN}. The underlying operation of the comparator 230 does not change while converting the sampled V_{IN}. The “Comp_out” signal is still the result of a comparison between the sampled V_{IN} and the V_{DAC} from the DAC 220. The SAR control logic 210, however, keeps track of the “Comp_out” signals to control the operation of the SAR ADC 200.

The “adc_data” is the digital output of the SAR ADC 200, which is represented by the contents of the n-bit register of the SAR control logic 210. When a sampled V_{IN} is converted, the contents in the n-bit register, a word, represents the sampled V_{IN}. As mentioned above, scanning and acquiring data from the touch panel is carried out sequentially, per each sensing track. This mechanism enables the SAR ADC 200 to eliminate the time wasted in converting the non-touch responsive signals. To realize the benefit of the mechanism, the SAR control logic 210 outputs a data ready signal, such as “adc_aq”, to indicate that the result data is valid. Accordingly, in an embodiment, the SAR control logic 210 asserts the “adc_aq” as soon as the sampled signal fails the threshold check. In such cases, the SAR control logic 210 can be configured to provide a default data, or a null value, via the “adc data”.

### Exemplary Methods

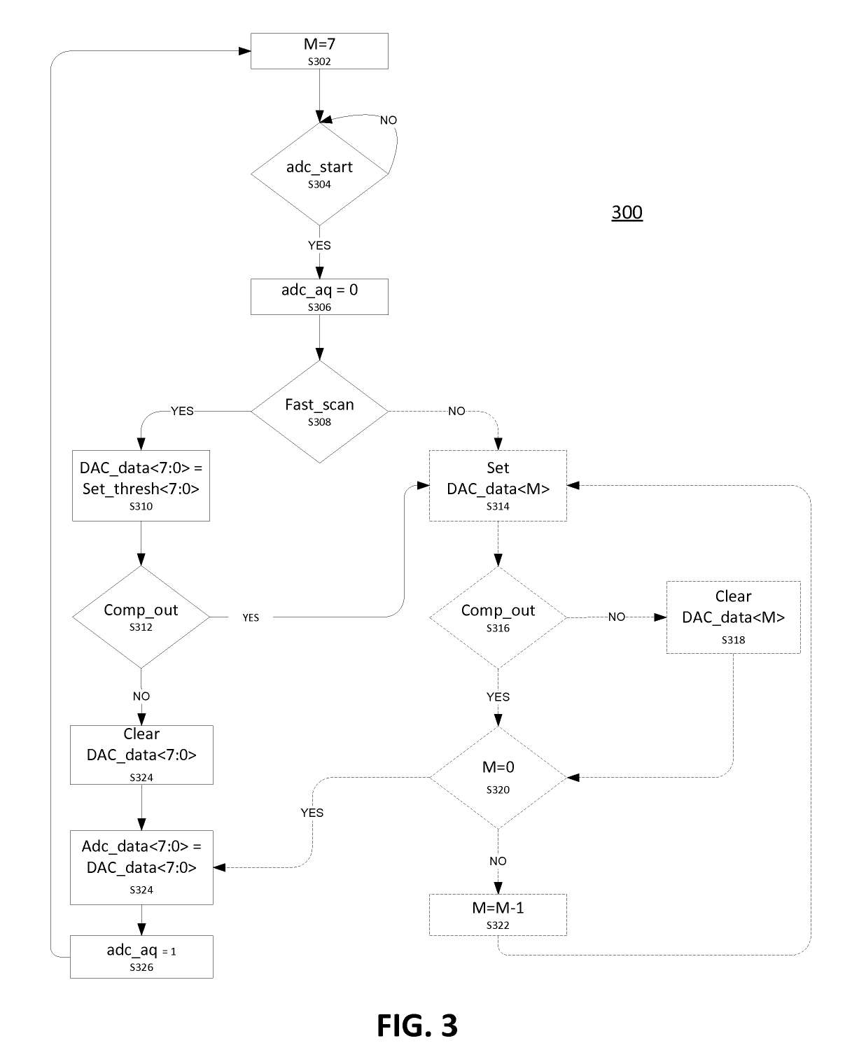

FIG. 3 is a simplified flowchart illustrating a method of using the selective data acquisition system in accordance with an embodiment of the present disclosure. The method described herein may be used in conjunction with any embodiments of the systems or circuits described in this disclosure. It should be noted that, in various embodiments, some of the steps may be performed concurrently, or in a different order than shown, or may be omitted. Additional steps may be performed as desired. The method 300 may operate as follows.

In S302, the n-bit register of the SAR control logic 210 is reset. This may be accomplished by the “rst_M” signal shown in FIG. 2. In S304, the SAR control logic 210 is held in the Idle mode until the “adc_start” signal is asserted. Upon the assertion of the “adc_start” signal, the “adc_aq” signal is set to “0” or a logic low in S306. As mentioned above, the “adc_aq” signal functions as a data ready signaling mechanism. In this example, asserting the “adc_aq” signal low by the SAR control logic 210 signals that the output at “adc_data” is not valid. In S308, the SAR control logic 210 checks for the operation mode of the SAR ADC 200. This may be achieved by the assertion or de-assertion of the “Fast_scan” signal described above. The assertion of the “Fast_scan” signal indicates that the sampled V_{IN} is an analog input from one of the sensing track of the touch panel. As discussed above, the “adc_start” signal, the “Fast_scan” signal, the “Set_thresh” signal, or any combination thereof, may be provided from the EC 120 or any other internal/external components. It is sufficient that the threshold data received via the “Set_thresh” signal corresponds to the sampled V_{IN}.

If the “Fast_scan” signal is asserted, in S310, the SAR control logic 210 configures the DAC 220 to output the received threshold data on the V_{DAC}. The sampled V_{IN} from the SH circuit 240 and the V_{DAC} from the DAC 220 are provided to the comparator 230 for a comparison (i.e., threshold check). Based on the comparison result in S312, the SAR control logic 210 either temporarily switches its operating mode to the conversion mode or continues to operate in the fast scan mode.

As described, the “Comp_out” signal from the comparator 230 is the result of

the comparison between the sampled V_{IN} and the V_{DAC}. In various embodiments provided in this disclosure, the comparator 230 is configured to provide a logic high when the sampled V_{IN} is greater than the V_{DAC}. Such a configuration, however, may vary in other embodiments.

In S312, if the “Comp_out” signal is set to a logic high, the SAR ADC 200 operates in the conversion mode. In FIG. 3, the steps performed by the SAR ADC 200 during the conversion mode are illustrated in the dotted line. It should be noted that the SAR ADC 200 could have been set to operate in the conversion mode initially, if the “Fast_scan” signal was not set. in S308. This mechanism allows for using the SAR ADC 200 for purposes other than to scan the touch panel. In the conversion mode, the SAR ADC 200 converts the sampled V_{IN} into a digital word by successively comparing the sampled V_{IN} with digital bit values of finer resolution. To implement this binary search algorithm, in S314, the SAR control logic 210 resets its register, so that the V_{DAC} is set to midscale of the V_{REF}. In other words, the most significant bit (“MSB”) of the register is set to “1”. This configures the V_{DAC} to be V_{REF}/2, where V_{REF} is the reference voltage provided to the SAR ADC 200.

In S316, a comparison is performed by the comparator 230 to determine if the sampled signal V_{IN} is less than, or greater than, the V_{DAC}. The operation of the comparator 230 in S316 is same as the operation in S312. It is only the purpose of the comparison, which differs between the steps S312 and S316. Unlike the comparison done in S312, the comparison in S316 is for the actual conversion of the sampled V_{IN}. If the V_{IN} is less than the V_{DAC}, the “Comp_out” is a logic low. In such a case, the MSB of the register is cleared to “0” or to a logic low as shown in S318. Conversely, if the sampled V_{IN} is greater than the V_{DAC}, the comparator output is “1” or a logic high, and the MSB of the register remains at “1”. In either cases, the SAR control logic 210 proceeds to check whether the sampled analog signal has been converted up to the least significant bit (“LSB”), as shown in S320. If the conversion is not carried out to the LSB, the SAR control logic 210 moves to the next bit down (S322), forces that bit high (S314), and performs another comparison (S316). Iteration continues all the way down to the LSB, and when the LSB is verified in S320, the conversion is completed. At the end, the 8-bit digital word for the sampled analog signal is available in the register.

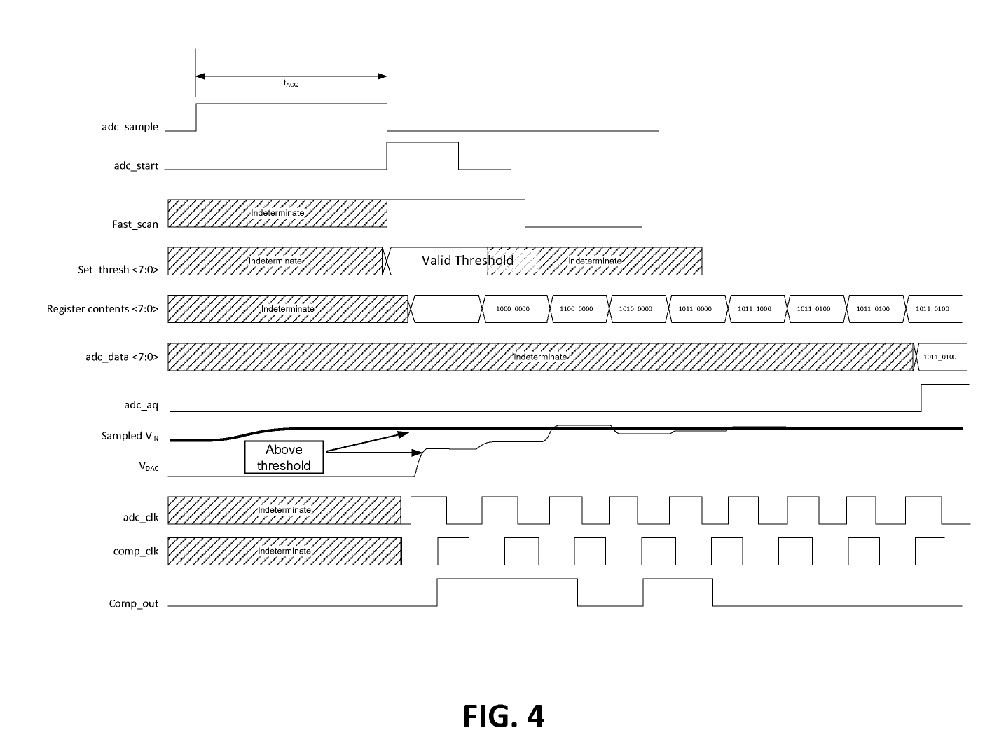

FIG. 4 is a timing diagram illustrating an exemplary operation of a SAR ADC 200 of an embodiment of the present disclosure. It should be noted that, in various embodiments, asserting or de-asserting of signals may be performed concurrently, or in a different order than shown, or may be omitted. The sampled signal is higher than the threshold in this example. The “adc_start” signal is held low during the track period. When sampling completes, the “adc_start” signal is held high. In this exemplary illustration, the “Fast_scan” signal is also asserted at the same time as the “adc_start”. The clocks for the comparator (“comp_clk”) and the SAR control logic (“adc_clk”) are out of phase by 90 degrees. Accordingly, the “adc_clk” can be used to load the DAC digital value, and the “comp_clk” can be used to clock the output of the comparator 230. In some embodiments, the assertion of the “Fast_scan” signal is used to indicate that the data received via the “Set_thresh” signal is valid. The SAR control logic 210 sets its register to the value received via the “Set_threshold” signal and waits an appropriate time for the DAC 220 and the comparator 230 to settle.

As mentioned above, the V_{DAC} is set to the threshold value in the initial clock cycle for each given V_{IN}. The sampled V_{IN} is greater than the V_{DAC}, and the SAR ADC 200 operates in the conversion mode to run the successive comparisons. At the start of a conversion, the SAR digital control 210 sets the register value such that all bits except the MSB produce a logic low or “0”. This sets the V_{DAC} to one-half of the full scale voltage input for the SAR ADC 200. Since the SAR ADC of this illustration uses an 8-bit register, bit 7 of the register is set to “1” and thus the content of the register (1000_{—}0000) is provided to the DAC 220. The first comparison by the comparator 230 shows that the V_{IN} is greater than the V_{DAC}. Thus, bit 7 remains at “1”. Subsequently, the next MSB of the register, bit 6, is set to “1”, and the register content (1100_{—}0000) is provided to the DAC 220. In the second comparison, the V_{IN} is lower than the V_{DAC}, and the bit 6 is set to “0”. Notice that, the “Comp_out” signal is held low to indicate the result of the comparison. In the iteration, bit 5 is set to “1”, and the register content (1010_{—}0000) is provided to the DAC 220. The “Comp_out” signal is now held high because the V_{IN} was greater than the V_{DAC}. This process continues until all 8 bits of the register are determined. At the completion, the content of the register is provided via the “adc_data”. Notice that the “adc_aq” signal, which was held low during the conversion, is now held high as the valid data is ready on the “adc_data”.

Referring back to FIG. 3, in S324, the 8-bit register is cleared, or otherwise set to a default value, as the “Comp_out” was set to a logic low in the previous step S312. In S326, the “adc_aq” signal is asserted high to signal that the data on the “adc_data” signal is valid.

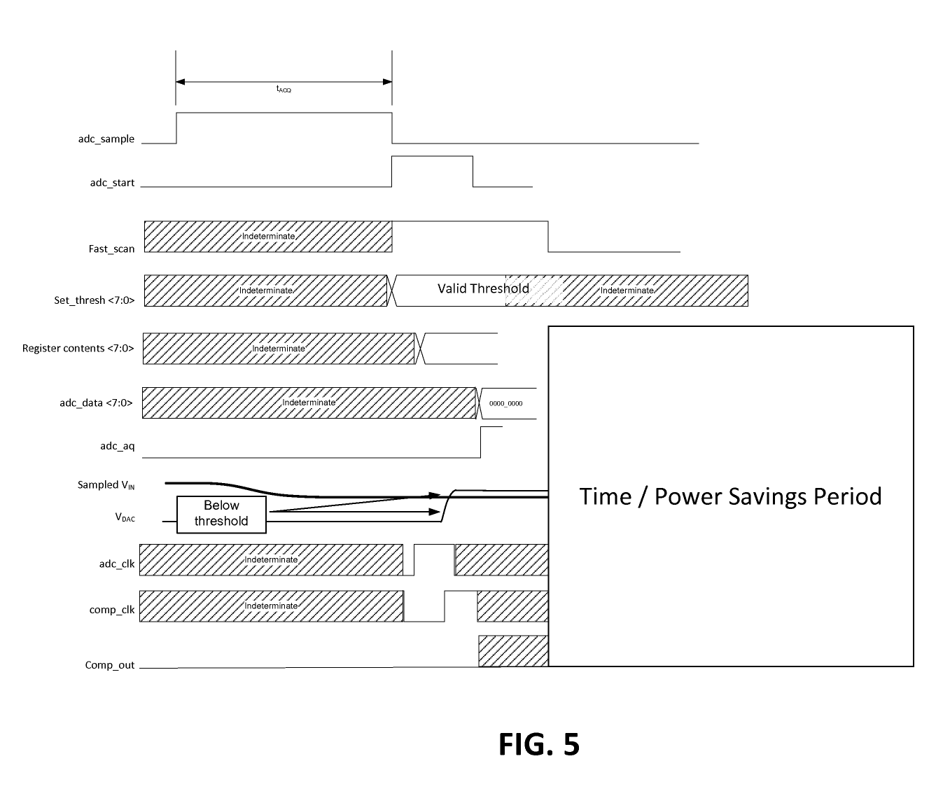

FIG. 5 is another timing diagram illustrating an exemplary operation of an embodiment of the SAR ADC 200. In this example, the sampled V_{IN} fell below the threshold. The “adc_aq” signal is asserted as soon as the SAR control logic 210 determines that the sampled V_{IN} needs not be converted. A default value, for example (0000_{—}0000), is provided on the “adc_data”. The default value can be set to any other value in various other implementations. As shown in this illustration, the SAR ADC 200 does not perform the successive approximation process on the sampled V_{IN} that does not meet the threshold. In this setting, no time is wasted on running the successive approximation process on the non-touch responsive signal.

The specification has described a selective data acquisition system as well as a method suitable for using said selective data acquisition system. The invention is, however, not limited to these examples. Embodiments have been described above with the aid of functional building blocks and timing diagrams illustrating the implementation of specified functions and relationships thereof. The boundaries of the functional building blocks and signals have been arbitrarily defined herein for the convenience of the description. Alternative boundaries can be defined so long as the specified functions and relationships thereof are appropriately performed. Also, the illustrated steps are set out to explain the embodiment shown, and it should be anticipated that ongoing technological development will change the manner in which particular functions are performed. These examples are presented herein for purposes of illustration, and not limitation. Alternatives (including equivalents, extensions, variations, deviations, etc., of those described herein) will be apparent, to persons skilled in the relevant art(s) based on the teachings contained herein. Such alternatives fall within the scope and spirit, of the invention.

What is claimed is:

1. A selective data acquisition system for a resistive touch panel, comprising:
a memory to sample an analog signal from a plurality of sensing tracks of the touch panel; and
a control logic to perform a threshold check on a sampled analog signal, using a threshold that corresponds to the sampled analog signal.

2. The selective data acquisition system of claim 1, wherein the control logic is configured to prohibit a conversion of the sampled analog signal when the sampled analog signal fails the threshold check.

3. The selective data acquisition system of claim 2, further comprising a source of thresholds to provide a plurality of thresholds to the control logic, wherein each threshold is optimized to determine a touch actuation from the analog signal of each sensing track.

4. The selective data acquisition system of claim 3, wherein the control logic is configured to select the sensing track for sampling of the analog signal.

5. The selective data acquisition system of claim 3, wherein the control logic is configured to select the threshold for the sampled analog signal from the source of thresholds.

6. The selective data acquisition system of claim 3, wherein the source of thresholds is configured to select the sensing track for sampling of the analog signal.

7. The selective data acquisition system of claim 6, wherein the source of threshold is configured to select the threshold for the sampled analog signal and provide the selected threshold to the control logic.

8. The selective data acquisition system of claim 3, wherein the analog signal of each sensing track of the touch panel is sampled in a predetermined order, and the source of thresholds provides the threshold for each of the sampled analog signals to control logic in the same predetermined order.

9. The selective data acquisition system of claim 3, wherein the control logic comprises: a successive approximation logic; and
a register operably coupled to the successive approximation logic, wherein the control logic outputs a content of the register.

10. The selective data acquisition system of claim 9, further comprising an analog-to-digital converter (ADC), wherein the ADC comprises:
a digital-to-analog converter (DAC) to convert an output of the control logic into an analog feedback signal; and
a comparator to compare the analog feedback signal with the sampled analog signal to provide a control signal to the control logic.

11. The selective data acquisition system of claim 10, wherein the control logic performs the threshold check by using the ADC.

12. The selective data acquisition system of claim 11, wherein the ADC is configured to convert the sampled analog signal, after verifying that the sampled analog signal passes the threshold check, but before sampling the next analog signal.

13. The selective data acquisition system of claim 3, wherein the memory is a capacitor.

14. The selective data acquisition system of claim 3, wherein the memory is a sample and hold circuit.

15. The selective data acquisition system of claim 3, wherein the threshold check is performed by measuring the sampled analog signal's amplitude.

16. The selective data acquisition system of claim 3, wherein the source of thresholds is a firmware.

17. The selective data acquisition system of claim 3, wherein the source of thresholds is a discrete microcontroller controlling a sequence of analog signals being sampled from the sensing tracks of the touch panel, and generating the threshold for the sampled analog signal.

18. A selective data acquisition system for a resistive touch panel, comprising:
an analog-to-digital converter (ADC) to effect a variable threshold checker; and
a source of thresholds to provide the variable threshold checker with a threshold corresponding to a sampled analog signal on a sensing track of the touch panel.

19. The selective data acquisition system of claim 18, wherein the analog signals on each sensing track of the touch panel are sampled in a sequential order, and the source of thresholds provides the threshold for each of the sampled analog signals to the ADC in the same sequential order.

20. The selective data acquisition system of claim 18, wherein the ADC is configured not to convert the sampled analog signal when the sampled analog signal fails a threshold check.

21. The selective data acquisition system of claim 20, wherein the ADC is configured to convert the sampled analog signal, after verifying that the sampled analog signal passes the threshold check, and before sampling the next analog signal.

22. The selective data acquisition system of claim 21, wherein the threshold is checked by measuring the sampled analog signal's amplitude.

23. The selective data acquisition system of claim 18, wherein the ADC is configurable to a plurality of operating modes via one or more signals from one or more other components.

24. The selective data acquisition system of claim 23, wherein the ADC is configurable to a conversion mode in which the ADC converts the sampled analog signal to a digital word.

25. The selective data acquisition system of claim 24, wherein the ADC is configurable to a scan mode in which the ADC compares the sampled analog signal against the threshold before converting said sampled analog signal to a digital word.

26. The selective data acquisition system of claim 25, wherein the operating mode of ADC is switched from the scan mode to the conversion mode based on a comparison result between the sampled analog signal and the threshold.

27. The selective data acquisition system of 18, wherein the ADC is a successive approximation register analog-to-digital converter (SAR ADC) comprising:
a successive approximation register (SAR) control logic to provide a digital output;
a digital-to-analog converter (DAC) to convert the digital output of the SAR control logic into an analog feedback signal; and
a comparator to compare the analog feedback signal with the sampled analog signal to provide a control signal to the SAR control logic.

28. The selective data acquisition system of 27, wherein the ADC is operably coupled with a sample-and-hold circuit having an input and an output, in which the sample-and-hold circuit input is operably coupled to generate a sample-and-held representation of a plurality of analog signals from a plurality of sensing tracks of a touch panel, and the sample-and-hold circuit output is operably coupled to provide the sampled analog signal to the comparator.

29. A method for selectively acquiring data from a matrix touch panel comprising:
sampling an analog signal from a sensing track of the matrix touch panel;
analyzing the sampled analog signal with a distinctive threshold for said sampled analog signal to determine whether one or more characteristics of the sampled analog signal is indicative of a touch actuation; and
converting the sampled analog signal when the sampled analog signal meets the threshold.

30. The method for selectively acquiring data from a matrix touch panel in claim 29, further comprising:
upon the completion of converting the sampled analog signal, providing a data ready signal to indicate that the ADC is ready to output valid data.

31. The method for selectively acquiring data from a matrix touch panel in claim 30, further comprising:
configuring the ADC to provide a predetermined default data when the sampled analog signal does not meet the threshold; and
providing a data ready signal to indicate that the ADC is ready to output valid data.

32. The method for selectively acquiring data from a matrix touch panel in claim 31, wherein the one or more characteristics of the sampled analog signal includes amplitude.

33. The method for selectively acquiring data from a matrix touch panel in claim 32, wherein analog signals from each sensing track of the touch panel are sampled in a sequential order and the distinctive threshold for each of the sampled signals is provided to the ADC by using the same sequential order.

34. The method of claim 29, wherein the distinctive thresholds are obtained from a non-volatile memory operably coupled to a device employing the matrix touch panel.

35. A selective data acquisition system comprising:
means for providing a distinctive threshold for each sampled analog signal; and
means for performing a threshold check and converting the sampled analog input signal into a corresponding digital word based on the result of the threshold check.

36. The selective data acquisition system of claim 35, further comprising:
means for indicating valid data.
